(19) United States
(12) Patent Application Publication
(10) Pub. No.: US 2009/0096623 A1
(43) Pub. Date: Apr. 16, 2009

(54) FLEXIBLE LIGHT CONTROL TOPOLOGY

(75) Inventor: PHILIPP ROOSLI, Niantic, CT (US)

Correspondence Address: CANTOR COLBURN, LLP, 20 Church Street, 22nd Floor, Hartford, CT, 06103, US

(73) Assignee: INNCOM INTERNATIONAL INC., NIANTIC, CT (US)

(21) Appl. No.: 12/250,111

(22) Filed: Oct. 13, 2008

Related U.S. Application Data
(60) Provisional application No. 60/979,227, filed on Oct. 11, 2007.

(51) Int. Cl. G08B 21/00

(52) U.S. Cl. 340/635

(57) ABSTRACT

A controls application where distributed wireless devices will be operated through a central processing device if the wireless network is reliably available and where the devices will operate with a local and configurable application during times when the wireless network is not available.

### BACKGROUND

The present invention relates to control schemes for wireless networks. In particular, the control schemes cover the operation of a controls network in two distinct modes, a first mode when the wireless network is operating properly and a second mode when the wireless network is not operating.

Current distributed controls feature devices with local control (e.g. a dimmable light switch) that can be operated from a remote control, such as a central controller. In this configuration, if a wireless network by which the central controller communicates with the devices to operate the devices is unavailable, the devices are still locally controllable by way of the designated user interface. A wireless light switch that describes such a system is available in U.S. Pat. Nos. 5,905,442 and 5,982,103. Similarly, technologies such as X10 have applied this strategy.

A problem with this system exists, however, in that the local user interface on the control devices will perform the same function, independently of the availability of a reliable wireless network.

### SUMMARY

In accordance with one aspect of the present invention, an electrical control device adapted to be mounted within an electrical box for controlling an electrical device is provided and includes an actuator to control a load, an interface, a transceiver to provide for communications between the device and a remote controller, and a processing unit to monitor the communications and to cause the device to react differently to user activities based on a status of the communications between the device and the remote controller.

In accordance with another aspect of the present invention, a local electrical device for use in a system of electrical devices is provided and includes an actuator to control an electrical load coupled thereto, a drive unit, disposed in signal communication with the actuator and operable in first and second modes, which, upon receiving a command, when operating in the first mode, transmits the command to a controller that drives the actuator and actuators of other electrical devices or, when operating in the second mode, drives the actuator, and a processing unit to determine whether the command is transmissible to the controller and to cause the drive unit to operate in the first or the second mode when the command is or is not transmissible to the controller, respectively.

In accordance with yet another aspect of the invention, a method of operating a local electrical device provided as part of a system of the local and remote electrical devices is provided and includes determining whether a communication state in effect between the local electrical device and a controller of the system, which is configured to drive actuators of the local and the remote electrical devices responsive to a command, is active or inactive, and upon reception of the command and when the communication state is active, transmitting the command to the controller, or, upon reception of the command and when the communication state is inactive, driving the actuator of the local electrical device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

FIG. 1 shows the topology of a distributed controls application; and

FIG. 2 shows the building blocks of a wireless light control device.

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

### DETAILED DESCRIPTION

The present invention is directed to an operation of distributed controlled devices dependent on the availability of a wireless network. If the wireless network is available, the local user interfaces do not provide any local operation but, rather, report back a user's interaction through the wireless link to a controller. The controller then performs a look-up function to map the user interaction to a controls operation. For example, the operations on a switch contained in a single-gang box dimmer could control the light of the originating device or operate a series of other lights such as controlling a virtual circuit or establishing a light mood.

However, if the wireless network is not available, instead of the function that is hosted by the controller, the device would perform an operation that will at least execute some of the expected functionality. This feature set allows for a creation of much more advanced control schemes with unitary controllers such as a single-gang light dimmer where the user interface on such as device can be overloaded with many more functions that by just controlling the device itself At the same time, the device will feature a fail-safe mode in case the communication link is not available so that the inhabitant of a dwelling is not robbed of the ability to control lights.

In a case in which a device contains more than one item for control, such as a single-gang box device that contains five switches and itself will control a single load, all of the buttons under normal operating conditions will report events to the central controller which performs the actual operation. In a situation in which a failure of the communications occurs, these buttons will control the local load directly or could make a visual/audible indication in case particular switch does not perform any function at all.

In another embodiment, a door bell system could report the do-not-disturb (DND) and make-up-room (MUR) status towards a door bell plate in the hallway of a hotel guestroom. It is possible, by way of either a hidden switch, a secret key combination or a portable security credential, such as an RFID tag, to inquire the guestroom occupancy so that staff members of the hotel do not need to knock on a door of an occupied room. Under normal conditions, when the mentioned devices are able to communicate with a controller that distributes the true state of occupancy, DND and MUR, the device can visualize these states in the hallway in a normal way by turning the respective indicators on. In a case in which the devices are not able to communicate with the controller, the states might be visualized in an alternate way.

For example, the occupancy query could result in a displaying of a red LED for indicating an occupied condition or a green LED for indicating an unoccupied condition while the device is able to receive the proper information from the controller. In case the communication link is down, the device can alternately blink the red and green LED, signaling that the status of the guestroom is unknown.

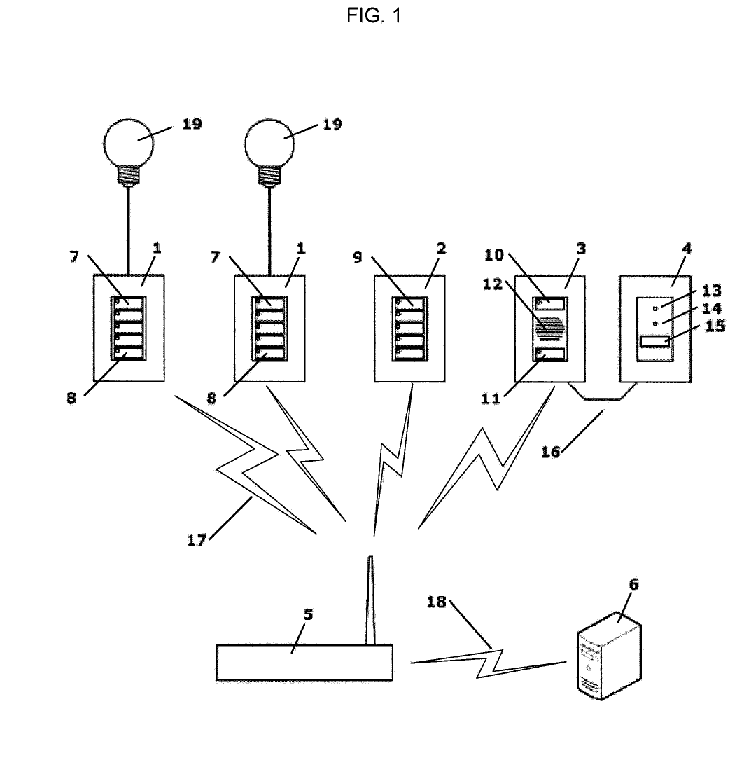

With reference now to the drawings, FIG. 1 shows an exemplary topology of a distributed control system. The system pictured shows two self-contained light dimmers 1, a programmable switch assembly 2, a door bell assembly with switches to set and clear, a do-not-disturb (DND) indicator and a make-up-room (MUR) indicator that are mounted next to the entry door inside a hotel guestroom 3, and a hallway mounted bell plate 4 with the ability to indicate the states and occupancy.

The controller 5 links the devices 1-4 together by way of networked communications, including, but not limited to, a wireless link 17. The controller 5 is linked, via a secondary network connection 18, to a server 6. The controller 5 is thereby able to offload data and perform building-wide control functions that are typically associated with a building control system.

The self contained dimmer 1 features one or multiple switches 7 and 8. In an embodiment of the invention, switch 7 shall be designated as operating the local light although this designation is merely exemplary. Here, when wireless link 17 is active (i.e., communication between the dimmer 1 and the controller 5 is available), switch 7 will send signals that are indicative of press and release events to controller 5. Controller 5 will then map these switch events into functions, such as a function for establishing a light scene, and, in accordance with a selected one of the functions, control an operation of all of the lights that are relevant to the selected function.

In contrast, in a case in which the wireless link 17 is not available, dimmer 1 performs a look-up in its local configuration memory to perform an alternate failsafe operation on its own load 19.

In a further embodiment of the invention, switch 8 switches between loads and states that are not associated with the light circuit 19. That is, switch 8 sends press and release events to controller 5 when the wireless link 17 is available and, when the wireless link 17 is not established, pressing switch 8 causes the dimmer 1 to perform, for example, a visual or audible indication to announce to the user that a key is physically accepted but does not lead to a valid operation.

The programmable switch assembly 2 contains a number of switches 9 with built-in indicators. If wireless link 17 is available, these switches 9 will send user interactions as events to controller 5 where the events will be mapped into specific functions which will result in updating the status indicators in devices 1-4. In a case in which the wireless link 17 is not available, pressing the switches 9 will result in a visual or audible error indication to the user.

In accordance with embodiments of the invention, devices 3 and 4 may include a doorbell kit. Device 3 is typically mounted next to the door inside the guestroom of a hotel while device 4 is typically mounted just outside the guestroom in the hallway. Device 3 features a switch 10 to control the do-not-disturb (DND) state of the guestroom. Another switch 11 is used to control the make-up-room (MUR) state of the guestroom. These states are displayed accordingly in the hallway on device 4 with indicators 13 and 14 respectively. Device 3 contains either a built-in sound system 12 to play a doorbell sound or operates an external, commercially available, chime.

As shown, device 3 provides power and communications to device 4. Because of the close proximity between devices 3 and 4 and the often unavailable power source in the hallway, such a configuration insures that device 4 is powered. However, it is conceivable that device 4 includes its own power source and a transceiver by which device 4 is able to communicate with controller 5.

Device 4 contains a doorbell pushbutton 15 that allows a visitor to ring the door bell. To inquire the occupancy status of the guestroom, button 15 could be pressed for more than five seconds and, in that case, display the occupancy status with indicators 13 and 14 instead of ringing the door bell. Of course, it is understood that other devices and methods are available for use in querying the occupancy status. These include, but are not limited to holding a RFID tag close to device 4 or by operating a secret switch.

Under normal condition when wireless link 17 is operating, controller 5 will be in communication with device 3 and the DND, MUR and occupancy states will be processed in controller 5. For example, the occupancy state might be synchronized with other guestrooms in case of a suite configuration where there are multiple controllers of type 5 involved. In a typical embodiment, server 6 will synchronize all controllers 5 of each room in a suite. The same is the case when light control commands will be used within suites. As an example, a light scene command might be established when key 7 of device 1 is pressed. This would be accomplished by sending an event from device 1 to controller 5. Controller 5 maps the event into a light scene command and sends it to all corresponding devices in the guestroom. At the same time, controller 5 sends the command to server 6 that then forwards the command to all other guestrooms that are part of the suite. In a case in which the wireless link 17 is not available, the switch would at least allow for local control of lamp 19 attached to device 1. If wireless link 17 is available, but link 18 to the server is not available, the switch would at least execute the light scene within the room that is managed by controller 5.

The link between controller 5 and server 6 can be in wireless form, such as ZigBee or WiFi. Other forms of communication could be wired Ethernet or twisted pair networks operating with the RS485 standard.

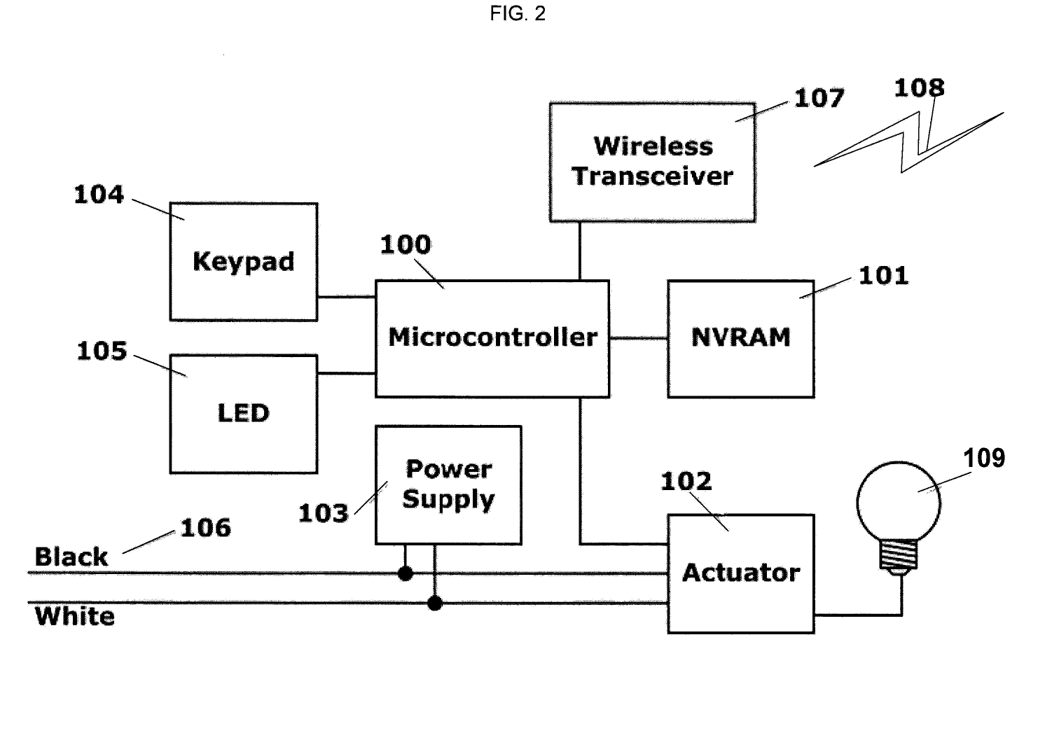

FIG. 2 shows the main building blocks of a unitary light dimmer 1 of FIG. 1. The heart of the device is a processing unit, such as a microcontroller 100, that performs all the functions under software control. A built-in wireless transceiver 107 allows the device to communicate through a wireless link 108 (i.e., wireless link 17, as described above) to a remote controller (i.e., controller 5, as described above). The link to the remote controller is monitored by microcontroller 100 and the link status is stored in its memory. The microcontroller 100 also scans the user interface, which is typically provided in the form of a keypad 104 and/or a credential sensing mechanism.

With this configuration, if a key is pressed or released on keypad 104 and the microcontroller 100 determines that the link to the remote controller is available, then the microcontroller 100 sends a signal indicating an event to the remote controller via the wireless transceiver 107 and the link 108. If the link is determined to be broken, however, the microcontroller 100 will alternately perform a look-up function in the non-volatile random access memory (NVRAM) 101. This configured memory contains a setup that instructs microcontroller 100 to perform an alternate function. This alternate function may include, but is not limited to, directly operating the built-in actuator 102 or by flashing an error pattern on the built-in LED indicators 105. The actuator 102 is able to control directly a single load 109, such as a light bulb. Actuator 102 could be in the form of a relay or in the form of a triac-based dimmer module.

As a self-contained device, the power supply 103 will provide the necessary power to the all the involved blocks in the device. The power can be provided by the AC-mains 106, such as 115 VAC, or by any other suitable power source.

The wireless transceiver 107 is active at all times and is, therefore, ready to receive from the controller commands to control the actuator 102 and, thereby, the load 109. In addition, the remote controller can also control the LEDs 105. Further, the remote controller can write a new configuration to NVRAM 101 during a setup process.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. An electrical control device adapted to be mounted within an electrical box for controlling an electrical device, the electrical control device comprising:
an actuator to control a load;
an interface;
a transceiver to provide for communications between the device and a remote controller; and
a processing unit to monitor the communications and to cause the device to react differently to user activities based on a status of the communications between the device and the remote controller.

2. The device according to claim 1, wherein the interface comprises switches and/or light emitting diodes (LEDs).

3. The device according to claim 1, wherein the actuator comprises a relay.

4. The device according to claim 1, wherein the actuator comprises a dimmer.

5. The device according to claim 1, wherein the communications include infrared (IR) signals.

6. The device according to claim 1, wherein the communications include radio frequency (RF) signals.

7. The device according to claim 1, wherein the communications are monitored based on a timeout of issued wireless commands.

8. The device according to claim 1, wherein the communications occur via a wireless network including repeaters.

9. The device according to claim 1, wherein the communications occur via a wireless network including a mesh network.

10. The device according to claim 1, wherein the communications comprise a command reflective of a user activity, which is transmitted to the controller when the communication state is active.

11. The device according to claim 10, wherein the user activity is processed locally when the communication state is inactive.

12. The device according to claim 10, further comprising a storage unit configured to store information relating to the user activity.

13. The device according to claim 11, further comprising a storage unit configured to store information relating to the user activity.

14. The device according to claim 1, wherein at least one of the first and second loads comprises a door bell.

15. The device according to claim 14, wherein the door bell comprises a relay to operate an external chime assembly.

16. The device according to claim 14, wherein the door bell comprises a sound synthesizer including an amplifier and a speaker.

17. The device according to claim 14, further comprising a switch and an indicator for indicating at least one of a do-not-disturb (DND) state or a make-up-room (MUR) state.

18. The device according to claim 14, wherein the processing unit receives occupancy status information from the controller.

19. A local electrical device for use in a system of electrical devices, the local electronic device comprising:
an actuator to control an electrical load coupled thereto;
a drive unit, disposed in signal communication with the actuator and operable in first and second modes, which, upon receiving a command, when operating in the first mode, transmits the command to a controller that drives the actuator and actuators of other electrical devices or, when operating in the second mode, drives the actuator; and
a processing unit to determine whether the command is transmissible to the controller and to cause the drive unit to operate in the first or the second mode when the command is or is not transmissible to the controller, respectively.

20. A method of operating a local electrical device provided as part of a system of the local and remote electrical devices, the method comprising:
determining whether a communication state in effect between the local electrical device and a controller of the system, which is configured to drive actuators of the local and the remote electrical devices responsive to a command, is active or inactive; and
upon reception of the command and when the communication state is active, transmitting the command to the controller, or upon reception of the command and when the communication state is inactive, driving the actuator of the local electrical device.
